(19) United States
(12) Patent Application Publication
(10) Pub. No.: US 2025/0183439 A1
(43) Pub. Date: Jun. 5, 2025

(54) HOLDER AND POWER STORAGE UNIT

(71) Applicant: Sumitomo Wiring Systems, Ltd., Yokkaichi-Shi, Mie (JP)

(72) Inventor: Toru TAKAHASHI, Yokkaichi-Shi, Mie (JP)

(73) Assignee: Sumitomo Wiring Systems, Ltd., Yokkaichi-Shi, Mie (JP)

(21) Appl. No.: 18/842,169

(22) PCT Filed: Feb. 10, 2023
(86) PCT No.: PCT/JP2023/004529

§ 371 Date: Aug. 28, 2024

(30) Foreign Application Priority Data
Mar. 1, 2022 (JP) 2022-030990

(51) Int. Cl. H01M 50/24; H01M 50/224; H01M 50/264; H01M 50/284; H01M 50/298

(52) U.S. Cl. CPC H01M 50/24; H01M 50/224; H01M 50/264; H01M 50/284; H01M 50/298

(57) ABSTRACT

A holder configured to hold a plurality of power storage elements arranged side by side includes: a plurality of recesses that respectively accommodate the plurality of power storage elements with the power storage elements exposed to an upper side in an up-down direction; a plurality of frame portions that each partition two recesses adjacent to each other; and a plurality of holding portions that respectively protrude toward the upper side from the plurality of frame portions and are configured to hold the power storage elements accommodated in the recesses. The plurality of holding portions include first holding portions contact the power storage elements accommodated in the recesses, and second holding portions contact with the power storage elements accommodated in the recesses. A first holding portion and a second holding portion provided in the same frame portion among the plurality of frame portions do not overlap.

### CROSS-REFERENCE TO RELATED APPLICATIONS

This application is the U.S. national stage of PCT/JP2023/004529 filed on Feb. 10, 2023, which claims priority of Japanese Patent Application No. JP 2022-030990 filed on Mar. 1, 2022, the contents of which are incorporated herein.

### TECHNICAL FIELD

The present disclosure relates to a holder and a power storage unit.

### BACKGROUND

Power storage units that accommodate a plurality of power storage elements are known. The power storage unit is used as, for example, an auxiliary power source that supplies power to in-vehicle electrical equipment when an abnormality occurs in a battery of a vehicle. For example, JP 2016-81795A discloses a power storage unit including a plurality of power storage devices (power double layer capacitors) held by a holder.

There is demand for reducing the size of a power storage unit. For example, although a plurality of power storage devices were conventionally held vertically by an upper holder and a lower holder, JP 2016-81795A discloses that a plurality of power storage devices are cantilevered by only a lower holder (the holder in JP 2016-81795A) to reduce the height of the power storage unit. In JP 2016-81795A, the power storage devices are held by a pair of holding portions provided on a holder.

The present disclosure aims to further reduce the size of the power storage unit.

### SUMMARY

A holder according to the present disclosure is a holder configured to hold a plurality of power storage elements arranged side by side in an arrangement direction, including: a plurality of recesses that respectively accommodate the plurality of power storage elements with the power storage elements exposed to an upper side in an up-down direction intersecting the arrangement direction; a plurality of frame portions that each partition two recesses that are adjacent to each other in the arrangement direction among the plurality of recesses; and a plurality of holding portions that respectively protrude toward the upper side from the plurality of frame portions and are configured to hold the power storage elements accommodated in the recesses, in which the plurality of holding portions include first holding portions configured to come into contact with the power storage elements accommodated in the recesses from one side in the arrangement direction, and second holding portions configured to come into contact with the power storage elements accommodated in the recesses from another side in the arrangement direction, and a first holding portion among the first holding portions and a second holding portion among the second holding portions provided in the same frame portion among the plurality of frame portions do not overlap in a view from the arrangement direction.

### Advantageous Effects

According to the present disclosure, the power storage unit can be made smaller.

### BRIEF DESCRIPTION OF DRAWINGS

FIG. 1 is a perspective view of a power storage unit according to an embodiment.

FIG. 2 is an exploded perspective view of the power storage unit shown in FIG. 1.

FIG. 3 is a cross-sectional view of the power storage unit taken along a cutting line indicated by an arrow III in FIG. 1.

FIG. 4 is an exploded cross-sectional view of the power storage unit shown in FIG. 3.

FIG. 5 is an exploded perspective view of a substrate unit according to the embodiment.

FIG. 6 is a plan view of the substrate unit according to the embodiment.

FIG. 7 is a perspective view showing part of a holder according to the embodiment.

FIG. 8 is a plan view showing part of the holder according to the embodiment.

FIG. 9 is a cross-sectional view showing part of the power storage unit according to the embodiment.

FIG. 10 is a cross-sectional view showing part of a power storage unit according to a modified example.

FIG. 11 is a plan view of part of a substrate unit according to a modified example.

### DETAILED DESCRIPTION OF PREFERRED EMBODIMENTS

The gist of the present disclosure includes the following configurations.

In a first aspect, a holder according to the present disclosure is a holder configured to hold a plurality of power storage elements arranged side by side in an arrangement direction, including: a plurality of recesses that respectively accommodate the plurality of power storage elements with the power storage elements exposed to an upper side in an up-down direction intersecting the arrangement direction; a plurality of frame portions that each partition two recesses that are adjacent to each other in the arrangement direction among the plurality of recesses; and a plurality of holding portions that respectively protrude toward the upper side from the plurality of frame portions and are configured to hold the power storage elements accommodated in the recesses, in which the plurality of holding portions include first holding portions configured to come into contact with the power storage elements accommodated in the recesses from one side in the arrangement direction, and second holding portions configured to come into contact with the power storage elements accommodated in the recesses from another side in the arrangement direction, and a first holding portion among the first holding portions and a second holding portion among the second holding portions provided in the same frame portion among the plurality of frame portions do not overlap in a view from the arrangement direction.

With this configuration, the width of the frame portions in the arrangement direction can be narrowed, allowing the holder to be made smaller.

In a second aspect, the first holding portion provided on one of two frame portions that are adjacent to each other in the arrangement direction among the plurality of frame portions may overlap with the first holding portion provided on the other of the two frame portions in a view from the arrangement direction.

With this configuration, the first holding portions and the second holding portions can be arranged repeatedly in a more compact manner, and therefore the width of each of the plurality of frame portions in the arrangement direction can be narrowed and the holder can be made even smaller.

In a third aspect, the first holding portion and the second holding portion provided in the same frame portion among the plurality of frame portions may partially overlap with each other in a view from a width direction intersecting the arrangement direction and the up-down direction.

With this configuration, the width of the frame portions in the arrangement direction can be made narrower, allowing the holder to be made even smaller.

In a fourth aspect, a plurality of the second holding portions may be provided on the frame portion, with a gap provided therebetween in the width direction, and the first holding portion provided on the same frame portion as the frame portion on which the plurality of second holding portions are provided may be located between the plurality of second holding portions in the width direction.

The plurality of second holding portions are located apart from each other in the width direction with the first holding portion interposed therebetween, and therefore the plurality of second holding portions can hold the power storage elements at two or more points spaced apart from each other in the width direction. This allows the power storage elements to be held more stably.

In a fifth aspect, the power storage unit according to the present disclosure includes: the holder according to any one of the first through the fourth aspects; the plurality of power storage elements held in the holder; a circuit board that includes wiring electrically connected to the power storage elements and is fixed to a lower side in the up-down direction of the power storage elements in the holder; and a metal case configured to accommodate the power storage elements and the holder by fixing an open end that is open to the lower side to the circuit board.

Since the power storage unit includes the above-described holder, the power storage unit can be made smaller.

In a sixth aspect, the holder may include one or more pillar portions protruding to the upper side relative to at least one of the plurality of power storage elements.

When the case bends toward the lower side due to vehicle vibrations or the like, the pillar portions come into contact with the case, thereby suppressing the bending of the case. This makes it possible to suppress short-circuiting between the case and the power storage elements caused by the bent case coming close to the power storage elements in the up-down direction.

The case may include an opposing wall opposing the plurality of power storage elements and the holder in the up-down direction, and the one or more pillar portions come into contact with the opposing wall before the at least one power storage element comes into contact with the opposing wall when the opposing wall bends toward the lower side.

With this configuration, a gap can be maintained between the opposing wall and the power storage elements, thereby suppressing short-circuiting of the power storage elements with the opposing wall.

In an eighth aspect, the wiring may include a ground line, the open end may be electrically connected to the ground line, and the one or more pillar portions may oppose the opposing wall with a gap therebetween in the up-down direction when the opposing wall is not bending in the up-down direction.

With this configuration, the effect of the tolerance of the pillar portions can be absorbed by the gap, and therefore it is possible to prevent the case from floating in the up-down direction from the circuit board. Also, by providing this gap, the pillar portions do not come into contact with the opposing wall when the opposing wall bends slightly, and the pillar portions can come into contact with the opposing wall only when the opposing wall bends so much that there is a risk of short-circuiting with the power storage elements. As a result, it is possible to reduce the load on the fastening portion between the case and the circuit board.

In a ninth aspect, the one or more pillar portions may include at least one of a first pillar portion protruding toward the upper side from a corner of the holder, and a second pillar portion protruding toward the upper side from a side of the holder.

By providing pillar portions at the corners or sides of the holder, the bent case can be supported and the pillar portions can increase the rigidity of the outer frame portion of the holder, thereby suppressing bending of the holder as well. This also makes it possible to prevent short-circuiting caused by the holder bending and the power storage elements held by the holder coming close to the case.

In a tenth aspect, the one or more pillar portions may include a third pillar portion protruding toward the upper side from the holding portion.

The third pillar portion is provided in the holding portion, and therefore can oppose the central region of the opposing wall in the up-down direction and support the portion of the opposing wall that bends significantly. This makes it possible to more reliably prevent short-circuiting between the power storage elements and the opposing wall.

Hereinafter, details of embodiments of the present disclosure will be described with reference to the drawings.

### Overall Configuration of Power Storage Unit 10

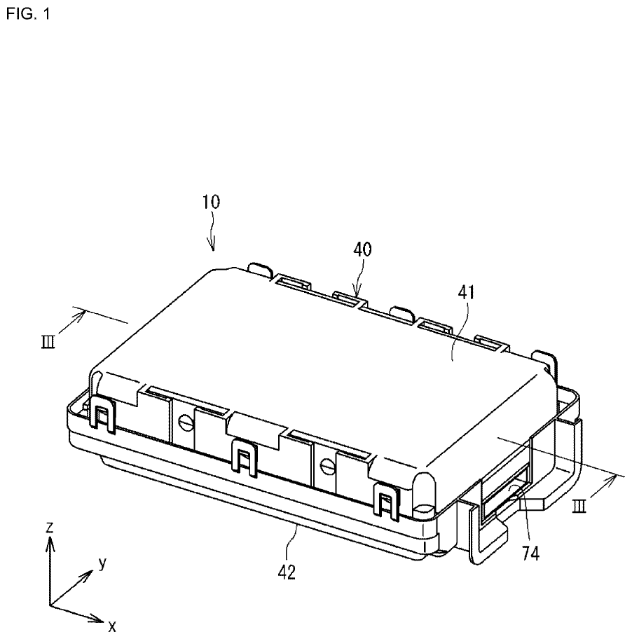

FIG. 1 is a perspective view of a power storage unit 10 according to the embodiment.

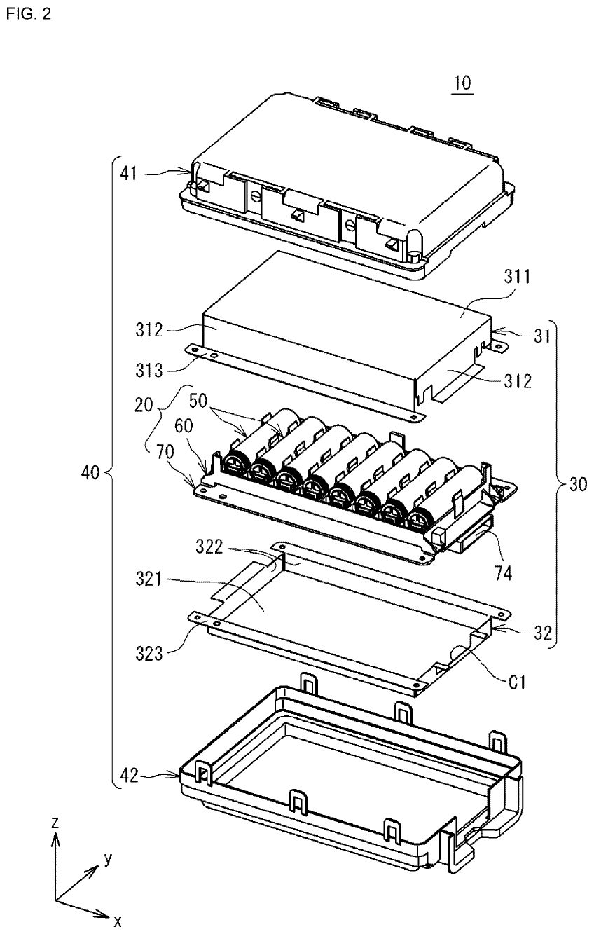

FIG. 2 is an exploded perspective view of the power storage unit 10 shown in FIG. 1.

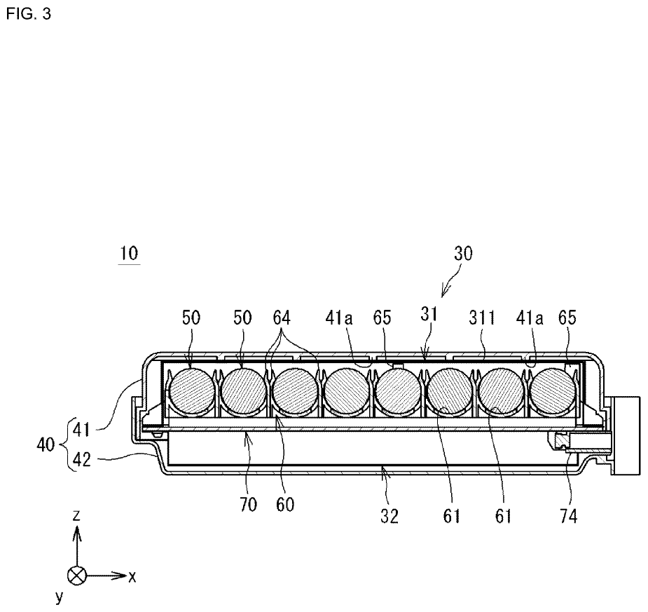

FIG. 3 is a cross-sectional view of the power storage unit 10 taken along the line indicated by arrow III in FIG. 1.

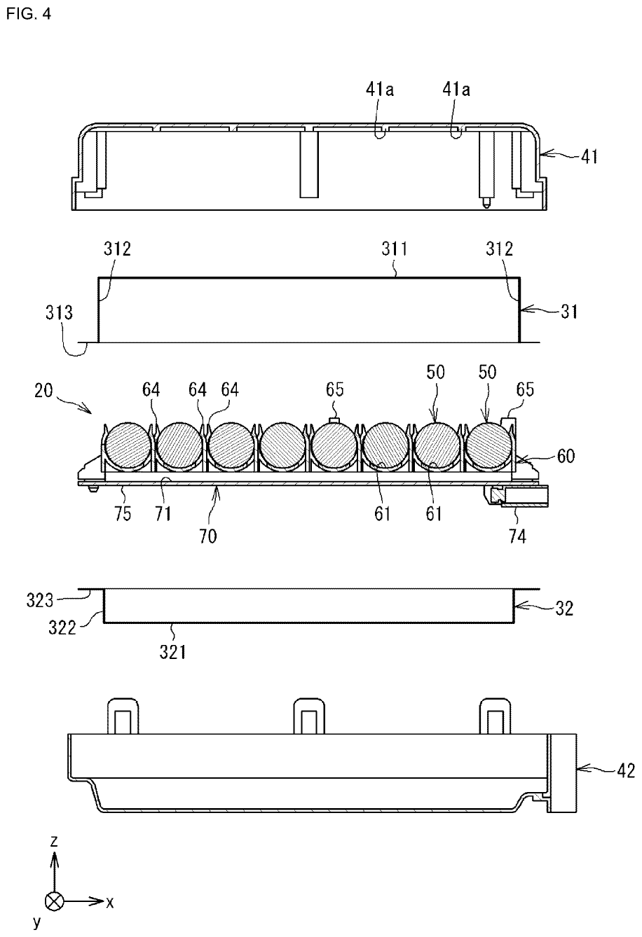

FIG. 4 is an exploded cross-sectional view of the power storage unit 10 shown in FIG. 3.

The power storage unit 10 is an auxiliary power source (backup power

source) that is mounted in, for example, a vehicle, and that, in the event of an abnormality such as a drop in voltage in a battery of the vehicle, supplies auxiliary power to various parts in the vehicle that are normally supplied with power by the battery. The power storage unit 10 may supply power to in-vehicle electrical equipment such as lamps, or may supply power to an actuator that controls a shift lever or the like of the vehicle.

As shown in FIG. 2, the power storage unit 10 includes a substrate unit 20, a shield unit 30, and a cover unit 40. The substrate unit 20 is accommodated in the shield unit 30, and the shield unit 30 is accommodated in the cover unit 40. That is, in the power storage unit, the substrate unit 20 is located at the innermost position and the cover unit 40 is located at the outermost position.

### Configuration of Substrate Unit 20

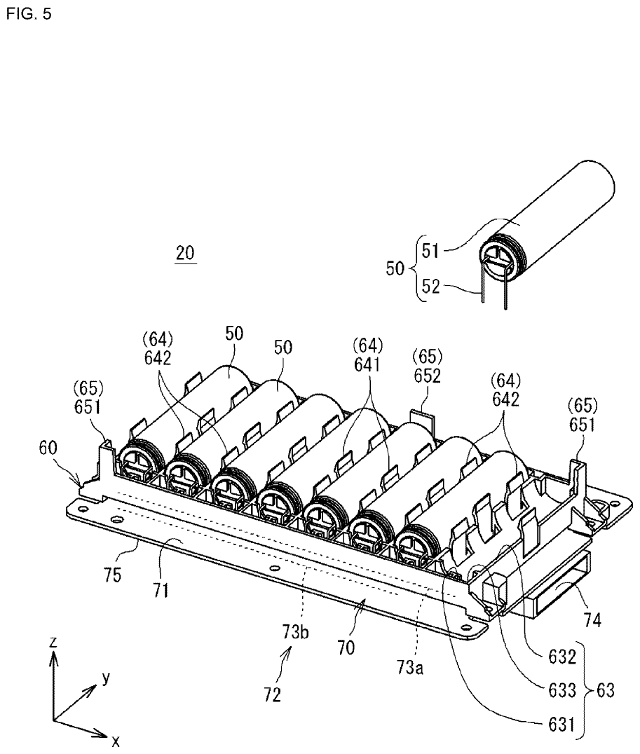

FIG. 5 is an exploded perspective view of the substrate unit 20.

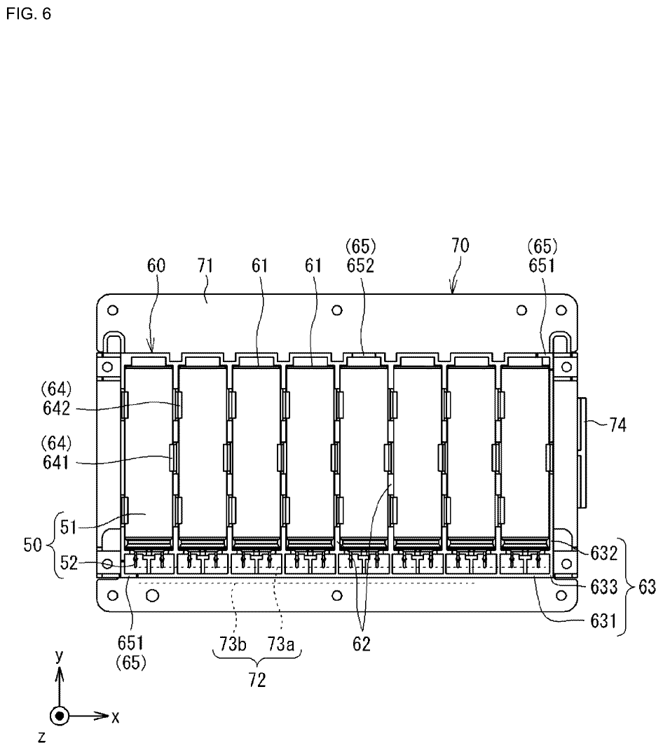

FIG. 6 is a plan view of the substrate unit 20.

The substrate unit 20 includes a plurality of power storage elements 50, a holder 60, and a circuit board 70. In this embodiment, eight power storage elements 50 are arranged in the arrangement direction, but the number of power storage elements 50 is not particularly limited. The holder 60 holds the plurality of power storage elements 50 with the power storage elements 50 exposed to an upper side in a direction (hereinafter referred to as the “up-down direction”) intersecting the arrangement direction. The circuit board 70 is fixed to the lower side of the holder 60 in the up-down direction.

The direction intersecting both the arrangement direction and the up-down direction is referred to as the “width direction”. In this embodiment, the arrangement direction, the vertical direction, and the width direction are perpendicular to each other. However, these directions may be oblique and do not need to be perpendicular to each other. In each drawing, the arrangement direction is indicated by an arrow x, the width direction is indicated by an arrow y, and the up-down direction is indicated by an arrow z. In the arrangement direction and width direction, the side indicated by the arrow is referred to as “one side” and the opposite side is referred to as the “other side”. In the up-down direction, the side indicated by the arrow is referred to as the “upper side” and the opposite side is referred to as the “lower side”. The up-down direction in each drawing is a direction for convenience and does not necessarily need to coincide with the vertical direction (direction of gravity) when the power storage unit 10 is installed.

In FIG. 5, one power storage element 50 located at an end in the arrangement direction is shown removed to the upper side from the holder 60. The power storage element 50 is, for example, a capacitor such as an electric double layer capacitor. Note that the power storage element 50 may be a battery such as a lithium ion battery. The power storage element 50 has, for example, a cylindrical shape that is elongated in the width direction and whose axis is oriented in the width direction. Note that the shape of the power storage element 50 is not particularly limited and may be, for example, a cuboid shape. The power storage element 50 includes a main body 51 and a terminal 52 protruding from the main body 51 to the other side in the width direction. The terminal 52 electrically connects the main body 51 to the circuit board 70.

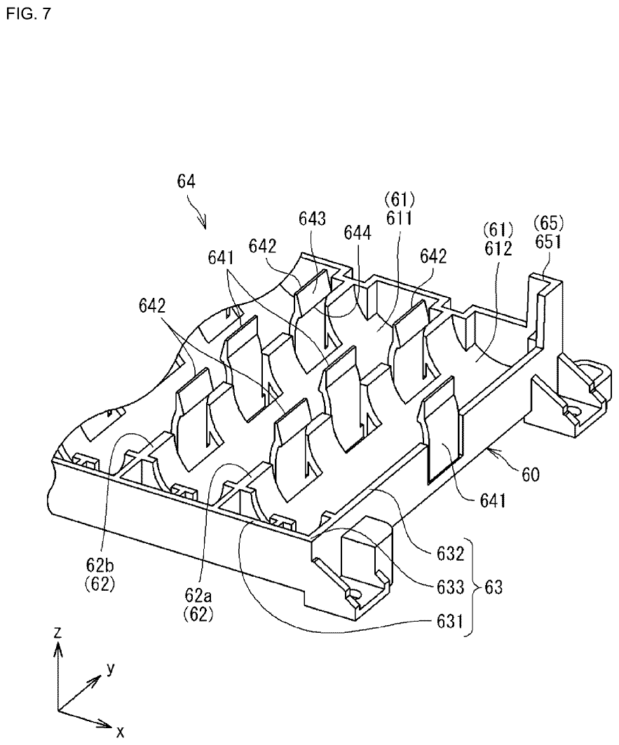

FIG. 7 is a perspective view showing part of the holder 60.

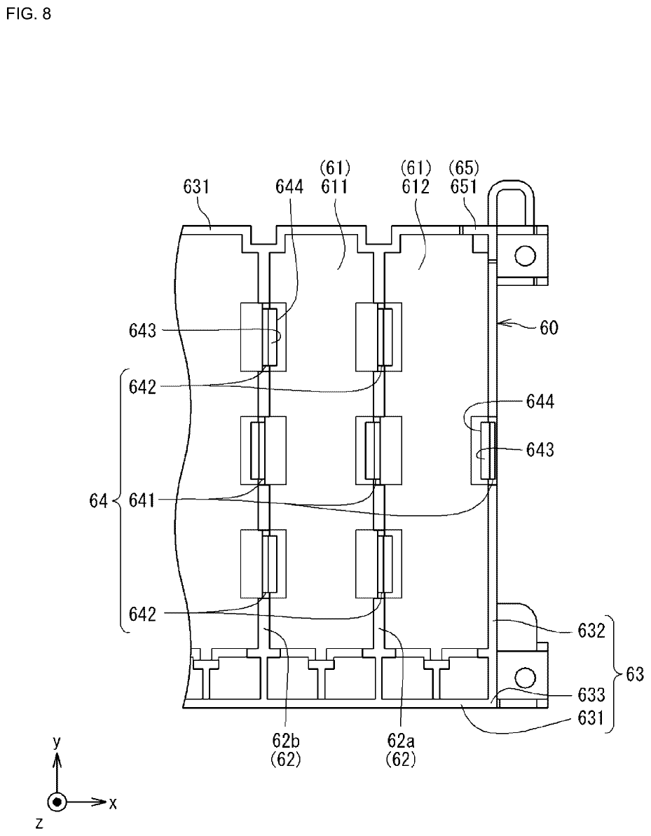

FIG. 8 is a plan view showing part of the holder 60.

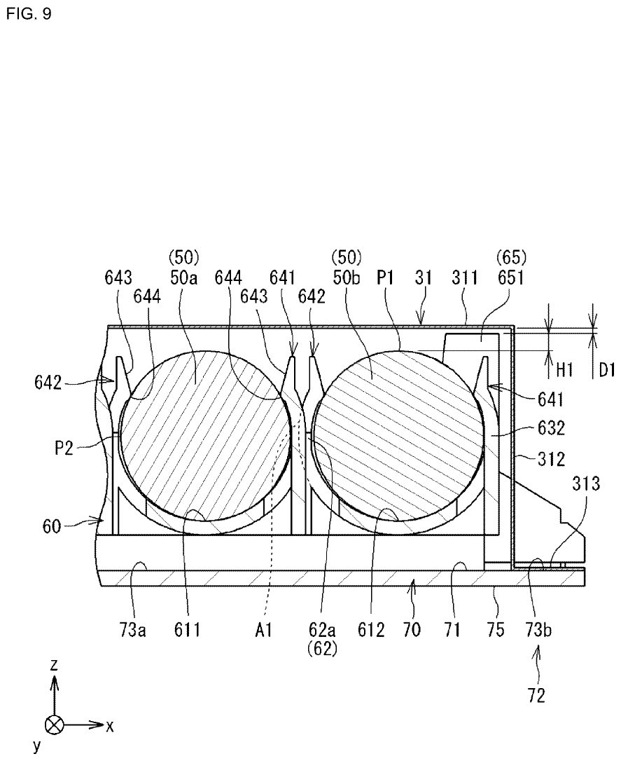

FIG. 9 is an enlarged cross-sectional view showing part of the cross-sectional view of FIG. 3.

FIGS. 7 and 8 will be referred to. The holder 60 is, for example, a resin member, and is integrally molded through injection molding or the like. Note that the holder 60 may also be constituted by a plurality of members. The holder 60 includes a plurality of recesses 61, a plurality of frame portions 62, an outer frame portion 63, a plurality of holding portions 64, and a plurality of pillar portions 65.

In this embodiment, eight recesses 61 are formed in the holder 60, which is the same as the number of power storage elements 50. Each of the plurality of recesses 61 accommodates one of the plurality of power storage elements 50. The shape of the recesses 61 corresponds to the outer circumferential shape of power storage elements 50, and in this embodiment, is a semi-cylindrical shape recessed to the lower side. The recesses 61 are open to the upper side. The power storage elements 50 are accommodated in the recesses 61 with portions thereof (specifically, the upper halves of the cylinders) exposed to the upper side.

The plurality of frame portions 62 are regions extending in the width direction, and each of the frame portions 62 partitions two recesses 61 adjacent to each other in the arrangement direction. In this embodiment, seven frame portions 62 are formed in the holder 60, which is one less than the number of recesses 61. Hereinafter, any one of the plurality of recesses 61 will be referred to as a “first recess 611” as appropriate, and the recess 61 adjacent to the first recess 611 on the one side in the arrangement direction will be referred to as a “second recess 612” as appropriate. In FIG. 7, the second recess 61 from the end on the one side in the arrangement direction is described as the first recess 611, and the recess 61 at the end on the one side in the arrangement direction is described as the second recess 612, but this is merely one example, and for example, the third recess 61 from the end may also be interpreted as the first recess 611.

Also, among the plurality of frame portions 62, the frame portion 62 that partitions the first recess 611 and the second recess 612 will be referred to as a “frame portion 62a” as appropriate. As shown in FIG. 9, the power storage element 50 accommodated in the first recess 611 will be referred to as a “first power storage element 50a” as appropriate, and the power storage element 50 accommodated in the second recess 612 will be referred to as a “second power storage element 50b” as appropriate.

The outer frame portion 63 is an outer frame formed on the four sides of the holder 60. The outer frame portion 63 includes two first side portions 631 extending in the arrangement direction, two second side portions 632 extending in the width direction, and four corner portions 633 where the first side portions 631 and second side portions 632 abut each other. The first side portions 631 and the second side portions 632 are the sides of the holder 60, and the corner portions 633 are the corners of the holder 60.

In each drawing, the lengths of the first side portions 631 in the arrangement direction are longer than the lengths of the second side portions 632 in the width direction. That is, the first side portions 631 are the long sides of the holder 60 and the second side portions 632 are the short sides of the holder 60. Note that the first side portions 631 may be the short sides of the holder 60, or the holder 60 may have a square shape in which the first side portions 631 and the second side portions 632 are equal in length.

The plurality of holding portions 64 are claw-shaped regions that protrude toward the upper side from the frame portions 62 or the second side portions 632. The plurality of holding portions 64 respectively come into contact with the power storage elements 50 accommodated in the recesses 61 to hold the power storage elements 50 in the recesses 61. In this embodiment, three holding portions 64 are provided on one frame portion 62 and one or two holding portions 64 are provided on one second side portion 632, but the number of holding portions 64 is not particularly limited.

Among the plurality of holding portions 64, the holding portion 64 that comes into contact with the power storage element 50 accommodated in the recess 61 from the one side in the arrangement direction (the right side in FIG. 8) is referred to as a “first holding portion 641”. Also, among the plurality of holding portions 64, the holding portion 64 that comes into contact with the power storage device 50 accommodated in the recess 61 from the other side in the arrangement direction (the left side in FIG. 8) is referred to as a “second holding portion 642”. The power storage element 50 according to this embodiment is held in the recess 61 at three points by one first holding portion 641 and two second holding portions 642.

FIG. 9 will be referred to. Each of the plurality of holding portions 64 includes a guide portion 643 and a contact portion 644. The guide portion 643 is provided at the leading end portion on the upper side of the holding portion 64 and is a region that guides the outer peripheral surface of the power storage element 50 when the power storage element 50 is inserted into the recess 61. The contact portion 644 is a portion of the holding portion 64 that comes into contact with the power storage element 50 accommodated in the recess 61. The contact portion 644 is provided, for example, below the guide portion 643.

The guide portion 643 includes an inclined surface. The inclined surface included in the guide portion 643 of the first holding portion 641 inclines to the one side in the arrangement direction toward the top. The inclined surface included in the guide portion 643 of the second holding portion 642 inclines to the other side in the arrangement direction toward the top. That is, the inclined surface is inclined so as to be located away from the center in the arrangement direction of the recess 61 in which the power storage device 50 guided by the guide portion 643 is accommodated.

When the power storage element 50 is inserted into the recess 61, the power storage element 50 is brought relatively close to the recess 61 in the up-down direction and first comes into contact with the guide portion 643. Then, the outer peripheral surface of power storage element 50 slides toward the lower side along the inclined surface of guide portion 643 and pushes out the guide portion 643 in the arrangement direction. At this time, the holding portion 64 is elastically deformed in the arrangement direction. When a vertex P2 in the width direction of the power storage element 50 at which the width in the arrangement direction is the widest passes over the guide portion 643 and the contact portion 644 toward the opposite side in the up-down direction, the elastic deformation of the holding portion 64 in the arrangement direction is reduced, and the contact portion 644 presses the power storage element 50 into the recess 61. As a result, the power storage element 50 is accommodated in the recess 61 while being held by the holding portion 64.

Here, in JP 2016-81795A, the two holding portions oppose each other with a recess interposed therebetween (paragraph 0038, FIGS. 7 and 9 of JP 2016-81795A). In contrast, in this embodiment, the first holding portion 641 and the second holding portion 642 provided on the same frame portion 62 (e.g., frame portion 62a) do not overlap in a view from the arrangement direction, as shown in FIG. 8. That is, in a view in the arrangement direction, in the frame portion 62a, the second holding portion 642 is not formed in the portion where the first holding portion 641 is formed, and the first holding portion 641 is not formed in the portion where the second holding portion 642 is formed.

With this configuration, the width of the frame portion 62 in the arrangement direction can be narrowed, and therefore the holder 60 can be made smaller. As a result, the power storage unit 10 can be made smaller.

Also, as shown in FIG. 9, the first holding portion 641 and the second holding portion 642 provided in the same frame portion 62a at least partially overlap with each other (portion shown in region A1) in a view in the width direction. With this configuration, the width of the frame portion 62 in the arrangement direction can be made narrower, and therefore the holder 60 can be made even smaller.

FIG. 8 will be referred to. A frame portion 62 adjacent to the other side in the arrangement direction of a frame portion 62a is referred to as a “frame portion 62b”. The first holding portion 641 provided on the frame portion 62a overlaps with the first holding portion 641 provided on the frame portion 62b in a view from the arrangement direction. Also, the second holding portions 642 provided on the frame portion 62a overlap with the second holding portions 642 provided on the frame portion 62b in a view from the arrangement direction. That is, the first holding portions 641 and the second holding portions 642 are arranged in a staggered manner (in a staggered pattern).

With this configuration, the first holding portions 641 and the second holding portions 642 can be arranged repeatedly in a more compact manner, and therefore the width of each of the plurality of frame portions 62 in the arrangement direction can be narrowed, and thus the holder 60 can be made even smaller.

As shown in FIG. 8, a plurality of second holding portions 642 (two in the example of FIG. 8) are provided on the frame portion 62a with a gap therebetween in the width direction. The first holding portion 641 provided on the frame portion 62a is located between the two second holding portions 642 in the width direction. That is, one of the two second holding portions 642 is located on one side in the width direction of the first holding portion 641, and the other of the two second holding portions 642 is located on the other side in the width direction of the first holding portion 641.

In this manner, the plurality of second holding portions 642 are located apart from each other in the width direction with the first holding portion 641 interposed therebetween, and therefore the power storage elements 50 can each be held at two or more points spaced apart from each other in the width direction. This allows the power storage elements 50 to be held more stably.

Also, two second holding portions 642 are provided on the frame portion 62b with a gap therebetween in the width direction. The first holding portion 641 provided on the frame portion 62a is located between the two second holding portions 642 in the width direction. That is, the first power storage element 50a is held at two locations from the other side in the arrangement direction, and at one location between the two locations from the one side in the arrangement direction. This makes it possible to more stably hold the first power storage element 50a while reducing the number of holding portions 64 that hold the first power storage element 50a.

FIGS. 7 and 9 will be referred to. The plurality of pillar portions 65 are members for preventing the power storage elements 50 from short-circuiting with the shield unit 30. When the case 31 included in the shield unit 30 bends toward the lower side due to vehicle vibration or the like, the pillar portions 65 come into contact with the case 31, thereby suppressing the bending of the case 31. This prevents short-circuiting between the case 31 and the power storage elements 50 caused by the bent case 31 coming close to the power storage elements 50 in the up-down direction.

The plurality of pillar portions 65 protrude toward the upper side relative to at least one of the plurality of power storage elements 50 (e.g., the first power storage element 50a) among the plurality of power storage elements 50 respectively accommodated in the plurality of recesses 61. In this embodiment, the plurality of power storage elements 50 have the same shape as each other, and the plurality of recesses 61 also have the same shape as each other, and therefore the plurality of pillar portions 65 protrude toward the upper side relative to all of the plurality of power storage elements 50. As shown in FIG. 9, the pillar portions 65 protrude in the up-down direction relative to the upper vertex P1 of the power storage element 50 by a height H1, for example.

As shown in FIG. 5, the plurality of pillar portions 65 include first pillar

portions 651 and a second pillar portion 652. The first pillar portions 651 are pillar portions 65 among the plurality of pillar portions 65 that protrude toward the upper side from corners of the holder 60 (that is, corner portions 633). The second pillar portion 652 is a pillar portion 65 among the plurality of pillar portions 65 that protrudes toward the upper side from a side of the holder 60 (that is, the first side portion 631 or the second side portion 632).

By providing the pillar portions 65 at the corners or sides of the holder 60, the bent case 31 can be supported, and the pillar portions 65 can increase the rigidity of the outer frame portion 63 of the holder 60, and therefore bending of the holder 60 can also be suppressed. This also makes it possible to prevent short-circuiting caused by the holder 60 bending and the power storage elements 50 held by the holder 60 coming close to the case 31.

FIGS. 5 and 6 will be referred to. The circuit board 70 is a substrate including a control circuit that controls the charging and discharging of the plurality of power storage elements 50. The circuit board 70 is fixed to the lower side of the holder 60 by fastening members such as bolts and nuts, with a circuit surface 71 on which wiring 72 is formed facing the upper side. The wiring 72 includes a region that is electrically connected to the power storage elements 50. The plurality of power storage elements 50 are connected in series to the wiring 72, for example. The wiring 72 has a power source line 73a connected to the power source side (positive side) of the vehicle, and a ground line 73b connected to the ground potential of the vehicle body or the like.

The circuit board 70 has a connector portion 74 that electrically connects the wiring 72 to external wiring, and a connector surface 75 (underside surface) that is the surface on the underside of the circuit surface 71 and on which the connector portion 74 is provided. The electric power extracted from the plurality of power storage elements 50 to the wiring 72 is supplied to the external wiring via the connector portion 74.

### Configuration of Shield Unit 30

FIGS. 2 to 4 will be referred to. The shield unit 30 functions as a shield for protecting the plurality of power storage elements 50 from external noise. The shield unit 30 includes a metal case 31 and a metal partner case 32. The case 31 is a substantially cuboid-shaped housing that is open to the lower side. The thickness of the case 31 is, for example, within a range of 0.2 mm or more and 0.8 or less, and is specifically 0.5 mm, for example. The case 31 is made of SPCC (cold rolled steel plate) or a steel material such as SUS304, for example. The partner case 32 is a substantially cuboid-shaped housing that is open to the upper side, and is made of the same material and has the same thickness as the case 31, for example.

The case 31 includes an opposing wall 311, side walls 312, and an open end 313. The opposing wall 311 is a wall that opposes the plurality of power storage elements 50 and the holder 60 in the up-down direction, and in this embodiment is a plate-shaped region that extends in the arrangement direction and the width direction. The side walls 312 are four walls extending toward the lower side from the peripheral edge of the opposing wall 311, and are a region that supports the opposing wall 311 in a state in which the opposing wall 311 opposes the plurality of power storage elements 50 and the holder 60.

The open end 313 is an end portion provided on the lower sides of the side walls 312. The case 31 is open to the lower side at the open end 313. The open end 313 of this embodiment is provided on the lower side of the case 31 in a “brim” shape.

The open end 313 is fixed to the circuit surface 71 of the circuit board 70 by fastening members (not shown) such as bolts and nuts, while being electrically connected to the ground line 73b of the circuit board 70. As a result, the entire case 31 is at ground potential. By accommodating the plurality of power storage elements 50 together with the holder 60 in the case 31 at ground potential, the power storage elements 50 can be protected from electrical noise outside of the case 31.

Similarly to the case 31, the partner case 32 includes an opposing wall 321, side walls 322, and an open end 323. The opposing wall 321 is a wall that opposes the connector surface 75 of the circuit board 70 in the up-down direction, and in this embodiment is a plate-shaped region that extends along the arrangement direction and the width direction. The side walls 322 are four walls extending toward the upper side from the peripheral edge of the opposing wall 321, and are a region that supports the opposing wall 321 in a state in which the opposing wall 321 opposes the connector surface 75. The side walls 322 include a notch C1 for exposing the connector portion 74 to the outside.

The open end 323 is an end portion provided on the upper side of the side wall 322. The partner case 32 is open to the upper side at the open end 323. In this embodiment, the open end 323 is provided on the upper side of the partner case 32 in a “brim” shape.

The open end 323 is fixed to the connector surface 75 of the circuit board 70 by fastening members (not shown) such as bolts and nuts, while being electrically connected to the ground line 73b of the circuit board 70. As a result, the entire partner case 32 is at ground potential, and the shield unit 30 is at ground potential. By accommodating the substrate unit 20 in the shield unit 30 at ground potential, the substrate unit 20 can be more reliably protected from electrical noise outside of the shield unit 30.

The relationship between the opposing walls 311 of the case 31 and the pillar portions 65 will be described with reference to FIG. 9. Since the opposing wall 311 is made of metal, if the opposing wall 311 and the power storage elements 50 come close to each other (or come into contact with each other), the electric charge stored in the power storage elements 50 may flow to the opposing wall 311, resulting in short-circuiting. For this reason, it is preferable that the gap in the up-down direction between the opposing wall 311 and the power storage elements 50 is large from the viewpoint of preventing short-circuiting. On the other hand, it is preferable that the gap is small from the viewpoint of reducing the size of the power storage unit 10.

For this reason, the gap between the opposing wall 311 and the power storage elements 50 (the distance from the vertex P1 on the upper side of the power storage elements 50 to the opposing wall 311) is made as small as possible without causing short-circuiting between the power storage elements 50 and the opposing wall 311.

Here, it is preferable that the case 31 is thin from the viewpoint of reducing the size and weight of the power storage unit 10. However, if the case 31 is thin, in some cases, the opposing wall 311 will significantly bend toward the lower side due to, for example, vibrations of the vehicle in which the power storage unit 10 is mounted or the like. If the gap between the power storage elements 50 and the opposing wall 311 is made as small as possible without causing short-circuiting between the power storage elements 50 and the opposing wall 311, then when the opposing wall 311 bends toward the lower side in this manner, there is a risk that the power storage elements 50 will short-circuit with the opposing wall 311.

In view of this, in this embodiment, by supporting the opposing wall 311 that bends toward the lower side by the pillar portions 65, the opposing wall 311 is prevented from approaching the power storage elements 50. That is, when the opposing wall 311 bends toward the lower side, the pillar portions 65 come into contact with the opposing wall 311 before the power storage elements 50 come into contact with the opposing wall 311, thereby suppressing bending of the opposing wall 311. This makes it possible to maintain a gap between the opposing wall 311 and the power storage elements 50, thereby preventing the power storage elements 50 from short-circuiting with the opposing wall 311.

Here, when the opposing wall 311 is not bent in the up-down direction, the pillar portions 65 oppose the opposing wall 311 with a gap D1 therebetween in the up-down direction. That is, when the opposing wall 311 is not bent in the up-down direction, the pillar portions 65 are not in contact with the opposing wall 311.

Since the holder 60 is formed through, for example, injection molding, there may be a tolerance of, for example, about 0.1 mm in the height of the pillar portions 65 in the up-down direction. If the pillar portions 65 are arranged so as to be in constant contact with the non-flexible opposing wall 311, the tolerance of the pillar portions 65 may cause the case 31 to float above the circuit board 70 in the up-down direction, which may result in the electrical connection between the case 31 and the ground line 73b being cut off.

The pillar portions 65 in this embodiment oppose the non-flexible opposing wall 311 with the gap D1 therebetween in the up-down direction, and therefore the effect of the tolerance is absorbed by the gap D1, and the case 31 can be prevented from constantly floating in the up-down direction from the circuit board 70.

Also, in some cases, vibration causes the opposing wall 311 to bend slightly while a gap sufficient to prevent short-circuiting between the opposing wall 311 and the power storage elements 50 is maintained. In such a case, if the pillar portions 65 are configured to individually come into contact with the opposing wall 311, there is a risk that the pillar portions 65 will push the case 31 in the up-down direction every time the opposing wall 311 bends slightly, which will result in a load acting on the fastening portions between the case 31 and the circuit board 70. In this case, there is a risk that the bolts and nuts fastening the case 31 and the circuit board 70 will easily come loose, or the electrical connection between the case 31 and the ground line 73b will frequently come loose.

In this embodiment, due to the gap D1, the pillar portions 65 do not come into contact with the opposing wall 311 when the opposing wall 311 bends slightly, but can come into contact with the opposing wall 311 only when the opposing wall 311 bends so much that there is a risk of short-circuiting with the power storage elements 50. This reduces the load on the fastening portion between the case 31 and the circuit board 70. Also, the electrical connection between the case 31 and the ground line 73b can be maintained more continuously.

### Configuration of Cover Unit 40

FIGS. 2 to 4 will be referred to. The cover unit 40 includes a cover 41 made of resin and a partner cover 42 made of resin. The cover 41 is a substantially cuboid-shaped housing that is open to the lower side. The cover 41 covers the substrate unit 20 and the shield unit 30 from above. The cover 41 has a plurality of protrusions 41a formed on its inner side (the side facing the case 31). The protrusions 41a come into contact with the opposing wall 311 of the case 31 in the up-down direction, and prevent the opposing wall 311 from bending toward the upper side. That is, bending of the opposing wall 311 toward the upper side is suppressed by the protrusions 41a, and bending of the opposing wall 311 toward the lower side is suppressed by the pillar portions 65.

The partner cover 42 is a substantially cuboid-shaped housing that is open to the upper side. The partner cover 42 covers the substrate unit 20 and the shield unit 30 from below, with the connector portion 74 exposed to the outside.

In the power storage unit 10 of this embodiment, the shield unit 30 made of metal is located inside of the cover unit 40 made of resin. For this reason, the cover unit 40 can protect the shield unit 30 from a configuration outside of the power storage unit 10 (e.g., the frame of a vehicle body on which the power storage unit 10 is installed, etc.). Because of the protection provided by the cover unit 40, there is little problem even if the strength of the shield unit 30 is reduced. For this reason, by providing the cover unit 40, the shield unit 30 can be made thinner, and the weight of the power storage unit 10 can be reduced.

### Modified Examples

Modified examples of the embodiment will be described below. In the modified examples, portions that are unchanged from the embodiment are denoted by the same reference numerals and description thereof is omitted.

### Modified Example 1 of Pillar Portions 65

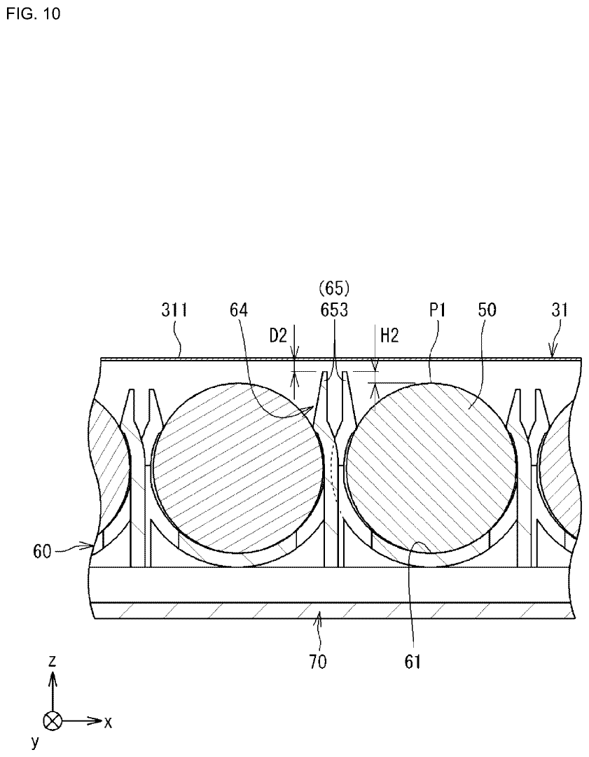

FIG. 10 is a cross-sectional view showing part of the power storage unit 10 according to a modified example.

The plurality of pillar portions 65 may include third pillar portions 653 protruding in the up down direction from the holding portion 64. For example, the third pillar portions 653 are formed by further extending the leading ends on the upper sides of the holding portions 64. The third pillar portions 653 are higher than the vertex P1 of the power storage elements 50 by a height H2, and oppose the opposing wall 311 with a gap D2 therebetween in the up-down direction.

The opposing wall 311 tends to bend more significantly the more spaced apart from the side wall 312 it is (that is, the closer to the central region in the arrangement direction and the width direction of the opposing wall 311 it is). Since the third pillar portions 653 are provided on the holding portions 64, the third pillar portions 653 can oppose the central region of the opposing wall 311 in the up-down direction and can support the portion of the opposing wall 311 that bends significantly. This makes it possible to more reliably suppress short-circuiting between the power storage elements 50 and the opposing wall 311. Also, since the third pillar portions 653 are additionally formed on top of the holding portions 64, which are structures provided for holding the power storage elements 50, the amount of resin required for their formation can be reduced compared to the first pillar portions 651 and the second pillar portions 652, which are formed on the outer frame portion 63. This makes it possible to reduce the weight of the power storage unit 10 and reduce the material cost of the resin.

The third pillar portions 653 may be formed on all of the holding portions 64 or on some of the holding portions 64. When the third pillar portions 653 are formed on some of the holding portions 64, for example, they may be formed on the holding portions 64 located in the center in the arrangement direction (in the example of FIG. 6, the three holding portions 64 provided on the fourth frame portion 62 from the left and right) or on the holding portions 64 located in the center in the width direction (in the example of FIG. 6, the eight first holding portions 641), thereby making it possible to support the portion of the opposing wall 311 that bends significantly.

### Modified Example 2 of Pillar Portions 65

In the above embodiment and modified example, the holder 60 is provided with a plurality of pillar portions 65. However, the number of pillar portions 65 provided on the holder 60 may be one. For example, only the holding portion 64 located the closest to the center (in the example of FIG. 6, the first holding portion 641 provided on the fourth frame portion 62 from the left and right) may be provided with only one third pillar portion 653. With this configuration, the number of pillar portions 65 can be reduced to reduce the weight of the power storage unit 10, and the portion of the opposing wall 311 that bends significantly can be supported.

### Modified Example 1 of Holding Portions 64

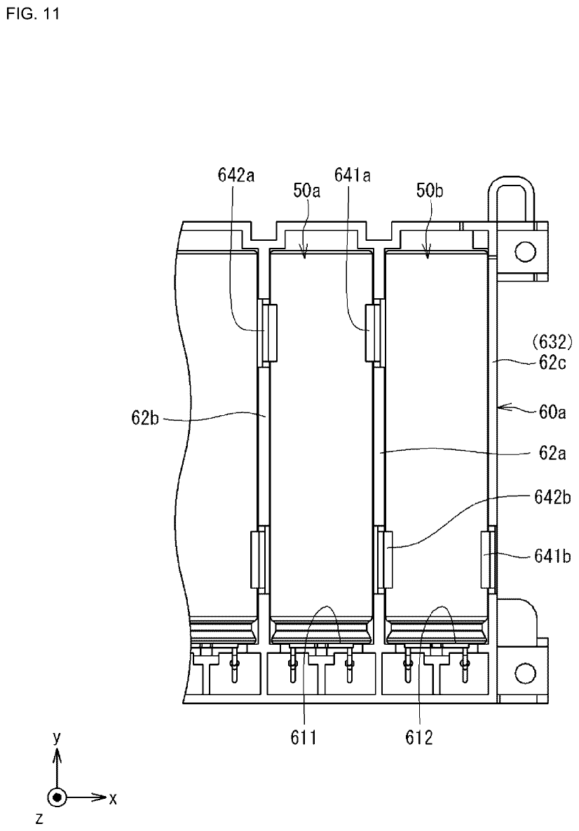

FIG. 11 is a plan view that schematically illustrates part of the power storage unit 10 according to a modified example.

In a holder 60a according to this modified example, the arrangement of the holding portions 64 is different from that of the holder 60 of the embodiment, but the other configurations are the same as those of the embodiment.

In the above embodiment, the holding portions 64 are arranged in a staggered pattern, and the first holding portion 641 and the second holding portions 642 that hold one power storage element 50 do not overlap in a view in the arrangement direction. However, the arrangement of the holding portions 64 of the present disclosure is not limited to this, and such first holding portions 641 and second holding portions 642 may overlap in a view in the arrangement direction.

In FIG. 11, the first holding portion 641 and the second holding portion 642 that hold the first power storage element 50a are referred to as a “first holding portion 641a” and a “second holding portion 642a”, respectively. Also, the first holding portion 641 and the second holding portion 642 that hold the second power storage element 50b are referred to as a “first holding portion 641b” and a “second holding portion 642b”, respectively.

One each of the first holding portion 641a and the second holding portion 642b is provided on the frame portion 62a that partitions the first recess 611 and the second recess 612. As in the above embodiment, in a view from the arrangement direction, the first holding portion 641a does not overlap with the second holding portion 642b.

The second holding portion 642a is provided on a frame portion 62b adjacent to the opposite side in the arrangement direction of the frame portion 62a. In a view from the arrangement direction, the second holding portion 642a overlaps with the first holding portion 641a, but does not overlap with the second holding portion 642b. Similarly, the first holding portion 641b is provided on a frame portion 62c (the second side portion 632 in the example of FIG. 2) adjacent to the frame portion 62a in the arrangement direction. In a view from the arrangement direction, the first holding portion 641b overlaps with the second holding portion 642b, but does not overlap with the first holding portion 641a.

In the above embodiment, the first holding portion 641 and the second holding portion 642 do not directly oppose each other in the arrangement direction, and therefore a plurality of power storage elements 50 can be held at the same location (holding conditions can be made uniform), but it was necessary to hold the power storage elements 50 at at least three locations.

In contrast, the second holding portion 642a according to the modified example directly opposes the first holding portion 641a in the arrangement direction, and therefore the first power storage element 50a can be stably held at two locations, namely the first holding portion 641a and the second holding portion 642a. Also, since the first holding portion 641b according to the modified example directly opposes the second holding portion 642b in the arrangement direction, the second power storage element 50b can be stably held at two locations, namely the first holding portion 641b and the second holding portion 642b. As a result, the number of holding portions 64 can be reduced and the weight of the power storage unit 10 can be reduced compared to the above embodiment.

### Modified Example 2 of Holding Portions 64

In the above embodiment, one power storage element 50 is held by three holding portions 64. However, the number of holding portions 64 used to hold one power storage element 50 is not particularly limited as long as it is two or more. Also, in the above embodiment, all of the power storage elements 50 are held by three holding portions 64, but the number of holding portions 64 that hold the power storage elements 50 in one holder 60 may be different.

For example, two power storage elements 50 that are accommodated in the recesses 61 that are adjacent to the outer frame portion 63 and are located at both ends in the arrangement direction may each be held by four holding portions 64, and the other storage elements 50 may each be held by three holding portions 64. Since the outer frame portion 63 has room for providing more holding portions 64 than the frame portion 62, more holding portions 64 may be provided.

Also, the power storage elements 50 accommodated in the recesses 61 near the center in the arrangement direction may be held by more holding portions 64 than the other power storage elements 50. The bending of the holder 60 tends to reach its maximum near the center in the arrangement direction. For this reason, by holding the power storage elements 50 accommodated in the portion with significant bending with more holding portions 64, the power storage elements 50 can be held more stably.

### APPENDIX

Note that at least some of the above-described embodiments and various modified examples may be combined with each other as appropriate. Also, the embodiments disclosed herein are to be considered as illustrative in all respects and not limiting. The scope of the present disclosure is defined by the claims, and all modifications within the meaning and scope of equivalency to the claims are intended to be encompassed therein.

1. A holder configured to hold a plurality of power storage elements arranged side by side in an arrangement direction, comprising:
a plurality of recesses that respectively accommodate the plurality of power storage elements with the power storage elements exposed to an upper side in an up-down direction intersecting the arrangement direction;
a plurality of frame portions that each partition two recesses that are adjacent to each other in the arrangement direction among the plurality of recesses; and
a plurality of holding portions that respectively protrude toward the upper side from the plurality of frame portions and are configured to hold the power storage elements accommodated in the recesses,
wherein the plurality of holding portions include
first holding portions configured to come into contact with the power storage elements accommodated in the recesses from one side in the arrangement direction, and
second holding portions configured to come into contact with the power storage elements accommodated in the recesses from another side in the arrangement direction, and
a first holding portion among the first holding portions and a second holding portion among the second holding portions provided in the same frame portion among the plurality of frame portions do not overlap in a view from the arrangement direction.

2. The holder according to claim 1, wherein the first holding portion provided on one of two frame portions that are adjacent to each other in the arrangement direction among the plurality of frame portions overlaps with the first holding portion provided on the other of the two frame portions in a view from the arrangement direction.

3. The holder according to claim 1, wherein the first holding portion and the second holding portion provided in the same frame portion among the plurality of frame portions partially overlap with each other in a view from a width direction intersecting the arrangement direction and the up-down direction.

4. The holder according to claim 3,
wherein a plurality of the second holding portions are provided on the frame portion, with a gap provided therebetween in the width direction, and
the first holding portion provided on the same frame portion as the frame portion on which the plurality of second holding portions are provided is located between the plurality of second holding portions in the width direction.

5. A power storage unit comprising:
the holder according to claim 1;
the plurality of power storage elements held in the holder;
a circuit board that includes wiring electrically connected to the power storage elements and is fixed to a lower side in the up-down direction of the power storage elements in the holder; and
a metal case configured to accommodate the power storage elements and the holder by fixing an open end that is open to the lower side to the circuit board.

6. The power storage unit according to claim 5, wherein the holder includes one or more pillar portions protruding to the upper side relative to at least one of the plurality of power storage elements.

7. The power storage unit according to claim 6,
wherein the case includes an opposing wall opposing the plurality of power storage elements and the holder in the up-down direction, and
the one or more pillar portions come into contact with the opposing wall before the at least one power storage element comes into contact with the opposing wall when the opposing wall bends toward the lower side.

8. The power storage unit according to claim 7,
wherein the wiring includes a ground line,
the open end is electrically connected to the ground line, and
the one or more pillar portions oppose the opposing wall with a gap therebetween in the up-down direction when the opposing wall is not bending in the up-down direction.

9. The power storage unit according to claim 6,
wherein the one or more pillar portions include at least one of
a first pillar portion protruding toward the upper side from a corner of the holder, and
a second pillar portion protruding toward the upper side from a side of the holder.

10. The power storage unit according to claim 6, wherein the one or more pillar portions include a third pillar portion protruding toward the upper side from the holding portion.
